(19) United States
(12) Patent Application Publication
(10) Pub. No.: US 2017/0163707 A1
(43) Pub. Date: Jun. 8, 2017

(54) METHOD AND DEVICE FOR PLAYING STREAMING MEDIA

(71) Applicants: LE HOLDINGS (BEIJING) CO., LTD., Beijing (CN); LE SHI XIN ELECTRONIC TECHNOLOGY (TIANJIN) LIMITED, Tianjin (CN)

(72) Inventors: Jianyong CUI, Tianjin (CN); Hong CAO, Tianjin (CN); Jijian ZHENG, Tianjin (CN)

(21) Appl. No.: 15/245,140

(22) Filed: Aug. 23, 2016

Related U.S. Application Data
(63) Continuation of application No. PCT/CN2016/089257, filed on Jul. 7, 2016.

(30) Foreign Application Priority Data
Dec. 3, 2015 (CN) 201510884222.9

(51) Int. Cl. H04L 29/06; H04L 12/24; H04L 12/861

(52) U.S. Cl. CPC H04L 65/604; H04L 49/90; H04L 41/0876

(57) ABSTRACT

An embodiment of the present disclosure discloses a method and a device for playing streaming media. The method comprises: pre-configuring a starting threshold for a player; when detecting a play command, acquiring time length information corresponding to buffer data, downloaded by the player; comparing the time length information with the starting threshold, determining status information of the player; and controlling the player to play streaming media according to the status information. Through pre-configuring the starting threshold for the player, the embodiment of the present disclosure avoids problem of low starting efficiency of the player caused by using a native threshold of Google, improving the starting efficiency and saving time for users.

### CROSS-REFERENCE TO RELATED APPLICATIONS

This application is a continuation of International Application No. PCT/CN2016/089257 filed on Jul. 7, 2016, which is based upon and claims priority to Chinese Patent Application No. 201510884222.9, entitled “METHOD AND DEVICE FOR PLAYING STREAMING MEDIA”, filed Dec. 3, 2015, the entire contents of all of which are incorporated herein by reference.

### TECHNICAL FIELD

The present disclosure generally relates to the video technical field, in particular to a method for playing streaming media and a device for playing streaming media.

### BACKGROUND

Along with the rapid development of scientific technology, popularization of terminals becomes faster and faster, and functions of terminals become richer and richer. Wherein, play function is an important function of terminals. Through the play function, the terminal can play streaming media, for example, playing news, TV series, movies, cartoons, music, etc. on web-pages.

During the process of realizing the present disclosure, the inventor found that, the terminal pre-downloads video data through a buffer area of a player, namely generating buffer data, then read the buffer data, and play the streaming media. Wherein, streaming media is transferred via a TV (Transfer Stream) data packet. This data packet is usually called Segment. When the buffer data is smaller than 3TS Segments, which means that when the length of the buffer data is smaller than the length of three TS data packets, the terminal will continue to buffer data, and a terminal system such as the Android system is set with starting conditions of the player according to a native threshold of Google. Wherein, the native threshold of Google is greater than 10 s. Therefore, when the time length of the current buffer data is greater than 10 s, which means that when the play time length of the current buffer data. is greater than 10 s, the terminal player can play streaming media. Taking play of network videos as an example, users need to wait for a period of time to watch network videos.

Obviously, existing terminal player has a low starting efficiency and wastes users' time.

### SUMMARY

The technical problem to be solved in the embodiment of the present disclosure is to provide a method for playing streaming media so as to improve the starting efficiency of a player.

Correspondingly, an embodiment of the present disclosure also provides a device for playing streaming media to ensure realization and application of the method.

To solve the problem above, an embodiment of the present disclosure discloses a method for playing streaming media, comprising;
pre-configuring a starting threshold for a player;
when detecting a play command, acquiring time length information corresponding to buffer data downloaded by the player;
comparing the time length information with the starting threshold and determining status information of the player;
and controlling the player to play streaming media according to the status information.

Correspondingly, an embodiment of the present disclosure discloses an electronic device for playing streaming media, comprising at least one processor; and a memory communicably connected with the at least one processor for storing instructions executable by the at least one processor, wherein execution of the instructions by the at least one processor causes the at least one processor to:
pre-configure the starting threshold for the player;
acquire the time length information corresponding to the buffer data downloaded by the player when detecting the play command;
compare the time length information with the starting threshold and determine the status information of the player;
control the player to play streaming media according to the status information.

An embodiment of the present disclosure discloses a non-transitory computer readable medium storing executable instructions that, when executed by a terminal, cause the terminal to: pre-configure the starting threshold for the player;
acquire the time length information corresponding to the buffer data downloaded by the player when detecting the play command;
compare the time length information with the starting threshold and determine the status information of the player;
control the player to play streaming media according to the status information.

Compared with the prior art, the embodiment of the present disclosure includes the following advantages.

The embodiment of the present disclosure can preset the starting threshold of the player, when detecting a play command, acquire the time length information corresponding to the buffer data downloaded by the player, then compare the time length information with the starting threshold, determine the status information of the player, and control the player to play the steaming media according to the status information, which means that the embodiment of the present disclosure can set the starting conditions of the player on the basis of the starting threshold of the player, thus avoiding the problem of low starting efficiency of the player because of use of the native threshold of Google, improving the starting efficiency, and saving users' time.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a step flowchart of a method for playing streaming media in accordance with some embodiments.

FIG. 2 is a step flowchart of a method for playing streaming media in accordance with some embodiments.

FIG. 3 is a structural block diagram of a device for playing streaming media in accordance with some embodiments.

FIG. 4 is a structural block diagram of a device for playing streaming media in accordance with some embodiments.

FIG. 5 schematically illustrates a block diagram of an electronic device for executing the method in accordance with some embodiments.

FIG. 6 schematically illustrates a storage unit for holding or carrying program codes for realizing the method m accordance with some embodiments.

### DESCRIPTION OF THE EMBODIMENTS

To clarify the objectives, technical solutions and advantage of the embodiments of the present disclosure, the technical solutions in embodiments of the present disclosure are clearly and completely described below with reference to drawings in the embodiments of the present disclosure. Obviously, the described embodiments are some embodiments of the present disclosure, not all the embodiments of the present disclosure. Based on the embodiments in the present disclosure, a person skilled in the art can obtain other embodiments without creative labor, which shall all fall within the protection scope of the present disclosure.

At present, a player plays streaming media such as videos, and is needed to comply with a play process. According to the play process, the basic play steps of the player include:
(1) data source setting: in this way the player can download source data needed to play the streaming media.
(2) initializing: after initialization is completed, the player enters a Prepare stage.
(3) Prepare stage: specifically, the player downloads the source data of the streaming media in the Prepare stage, generates buffer data; when play preparation is done, the player can enter a play status.
(4) Play status: meaning that the player can play the streaming media.
(5) Pause: meaning that the player can pause in the play status.
(6) Stop: meaning that the player stops to play after finishing play of the buffer data.

Usually, a terminal system adopts a native threshold of Google to set the starting conditions of the player. Taking the Android system as an example, a native code of the Android system uses the native threshold of Google to set the starting conditions of the player. Actually, the native code directly uses the native threshold of Google to set the starting conditions of the player. When the play time length of the buffer data downloaded by the player is greater than the native threshold, meaning that the time length of the buffer data is greater than the 10 s starting time set by the native code, and then the player can play the streaming media, thus reducing the starting efficiency of the player, and in particular in the case of poor network, resulting in that users wait for a long time, wasting uses time, and lowering down user experience.

Aiming at the above problems, a core concept of the embodiment of the present disclosure is to pre-configure a starting threshold for the player, compare the time length information corresponding to the buffer data with the starting threshold, determine the status information of the player, and control the player to play the streaming media according to the status information, so the player can play the streaming media when the play time length of the buffer data is relatively small, thus improving the starting efficiency of the player while shortening the users' time of waiting for play, and improving user experience at the same time.

Refer to FIG. 1, which illustrates a step flowchart of a method for playing streaming media according to an embodiment of the present disclosure. The method may specifically include the steps as follows.

Step 101: Pre-configure the starting threshold for the player.

Actually, the terminal system can set a proper starting threshold on network status information. Wherein, the network status information can include, but is not limited to information such as network bandwidth, network speed and network jittering, and the starting threshold can specifically refer to the starting time of the player. When the play time of the buffer data downloaded by the player is greater than the starting threshold, the player can play the streaming media, namely entering the play status. Taking the Android system of a mobile phone as an example, the starting threshold can be set as 1 s or 300 ms on the basis of the current network status information such as the bandwidth. Of course, for better user experience, along with the rapid development of network technologies, the player can be set with a smaller starting threshold. The embodiment of the present disclosure does not limit the starting threshold.

It is needed to be noted that, streaming media is also called streaming-oriented media, referring to continuous time-based media employing the streaming transfer technology in the Internet or Intranet, such as audio, video, multimedia files, etc. Optionally, streaming media at least include any one of the following types: audio, video and other multimedia files such as cartoons. For better understanding, videos are taken as an example below to describe the embodiment of the present disclosure, which should not be regarded as the limit in the embodiment of the present disclosure.

According to the network status information determined by the current network technology development level, rules for changing the starting threshold of the player can be set, so the starting time set by the native code can be reduced according to the preset rules for changing the starting threshold of the player to generate the starting threshold of the player. According to an optimal embodiment of the present disclosure, the step of pre-configuring the starting threshold for the player can include the sub-steps as follows.

Sub-step 10101: reducing the starting time set by the native code and generating a new starting time according to the preset change rules.

Sub-step 10101: configuring the starting threshold for the player on the basis of the new stating time.

Step 103, when detecting the play command, acquiring the time length information corresponding to the buffer data downloaded by the player.

Usually, a user watches videos through the player of a terminal, and needs to sends the play command to the player. The play command can be automatically generated by the system when the user selects a video, or generated by the player which is triggered through user's operation after a video is selected, for example, being generated after the user clicks a play button of the player. The embodiment of the present disclosure does not set a limit. For example, a user clicks an icon of a video to select the video that the user wants to watch, so the player can acquire video data corresponding to the video, enters the prepare stages, downloads the video data, and generates buffer data.

Actually, in the process of downloading the video data, the terminal system can test data stored in a buffer area of the player through a monitoring program, namely testing the current buffer data generated by the player, thereby determining the time required to play the buffer data. Based on the time required to play the buffer data, the time length information of the buffer data can be generated, for example 3 s. The time length information of the buffer data can be understood as the time length corresponding to the buffer data. When the player command is detected, the time length information, namely 3 s, corresponding to the current buffer data which has been generated by the player through calling interfaces, for example, calling an interface function getBufferedDurationUs( ).

Step 105: Comparing the time length information with the starting threshold and determining the status information of the player.

After the time length information corresponding to the current buffer data is acquired, the time length information is compared with the starting threshold configured in the player. According to comparison results, it is can be determined that if the player can complete the preparations for playing the video, and the status information of the player can be generated. For example, the status information of the player can be open status, closed status, etc. When the player completes the preparations for playing the videos, the player can enter the play status, and switches the state information of the player into the open status. Of course, when the player does not finish the preparations for playing the video, the status information of the player CM be set as the closed status. The embodiment of the present disclosure does not set a limit.

An a specific example of the embodiment of the present disclosure, when the time length information, namely 3 s, corresponding to the current buffer data downloaded by the player is greater than or equal to the starting threshold, namely 1 s, of the player, it can be determined that the player completes the preparations for playing the video and preparation completion information can be generated, for example a “prepare done” message; and the status information of the player is set as the open status, for example, setting a starting identifier flag of the player into “true”, namely flag=true. When the time length information, namely 400 ms, corresponding to the current buffer data downloaded by the player is smaller than the starting threshold, namely 1 s, of the player, it can be determined that the player does not complete the preparations for playing the video; and the status information of the player is set as the closed status, for example, setting a starting identifier flag of the player into “false”, namely flag=false.

Step 107: controlling the player to play streaming media according to the status information.

The player is controlled to play streaming media according to the status information of the player. Specifically when the status information of the player is open status, the player can play streaming media; for example, play videos through reading the buffer data in the buffer area. At this time, the user can watch the selected video through the player. When the status information of the player is not open status, for example, the status information is closed status; the player cannot play the video, namely cannot display the screen of the video or play audio data of the video.

In the embodiment of the present disclosure, the player can be pre-configured with the starting threshold on the basis of the network status information, avoid using the native threshold of Google to set the starting conditions of the player, and shortening the starting time of the player. Therefore, the player can play the streaming media when the play time length of the buffer data is relatively small, thus improving the starting efficiency of the player while shortening the users' time of waiting for play, and improving user experience at the same time.

In the process of watching the video, the user can regulate the play progress of the player by adjusting the play position of the progress bar of the player, for example dragging a slide indicator of the progress bar leftward or rightward, to watch interesting video contents. Wherein, the slide indicator's position at the play progress bar is the position of a video frame played by the player at the progress bar dragging the slide indicator leftward can be understood as a fast-backward operation through which the play progress bar of the player is adjusted to a video frame prior to the currently played frame; and dragging the slide indicator rightward can be understood as a fast-forward operation through which the play progress of the player is adjusted to a video frame next to the currently played frame. The play command can include an initial play command and an adjustment play command. Wherein, the initial play command refers to a play command detected by the player during the initial startup, namely the first preparation for the video play; the adjustment play command refers to a command detected during adjustment of the player progress, namely a play command detected when the player responds to the fast-backward or fast-forward operation.

In an optimal embodiment of the present disclosure, the play command includes an initial play command and an adjustment play command; the start threshold includes a preparation threshold and an adjustment threshold; and the preparation threshold is smaller than an adjustment threshold.

When detecting the initial play command, in order to allow the user to watch video screens in the shortest time, the player needs to display the video screens in the shortest time. Otherwise, the user may think that the video cannot be played after waiting for playing the video for a long time, lowering down user experience. Therefore, the player can be configured with the preparation threshold when player initially plays the video, so that the starting time of the video played by the player for the first time is shortened as much as possible, thus reaching the ultimate starting speed.

When detecting the adjustment command, namely when responding to the fast-forward and fast-backward operations of the user, the player can play the video quickly if the starting threshold is set to be too small (for example, identical with the preparation threshold), however the buffer data is too small, then the video will be finished soon, so the player enters the buffer stage again. Entering the buffer stage frequently, the player will get stuck, lowering down user experience. In order to avoid getting stuck, aiming at the fast-forward or fast-backward operations, the player can be configured with the adjustment threshold. Wherein, the adjustment threshold is greater than the preparation threshold, but the adjustment threshold cannot be set to be too large. Too large adjustment command causes too long waiting time to the user, affecting the user experience and reducing the starting efficiency. As a specific example of the embodiment of the present disclosure, on the basis of the network status information, optimally, the reparation threshold is set as 300 ms, and the adjustment threshold is set as 1 s.

Of course, the adjustment threshold can also include a fast-backward adjustment threshold and a fast-forward adjustment threshold. Wherein, aiming at the fast-backward operation, the set starting threshold of the player is the fast-backward adjustment threshold; and aiming at the fast-forward operation, the set starting threshold of the player is the fast-forward adjustment threshold. Of course, a person in the art can configure different starting thresholds for the player on the basis of different play actions. The embodiment of the present disclosure does not set a limit. Below, a player configured with two different starting thresholds is taken as an example to describe the embodiment of the present disclosure, which should not be regarded as the limit in the embodiment of the present disclosure.

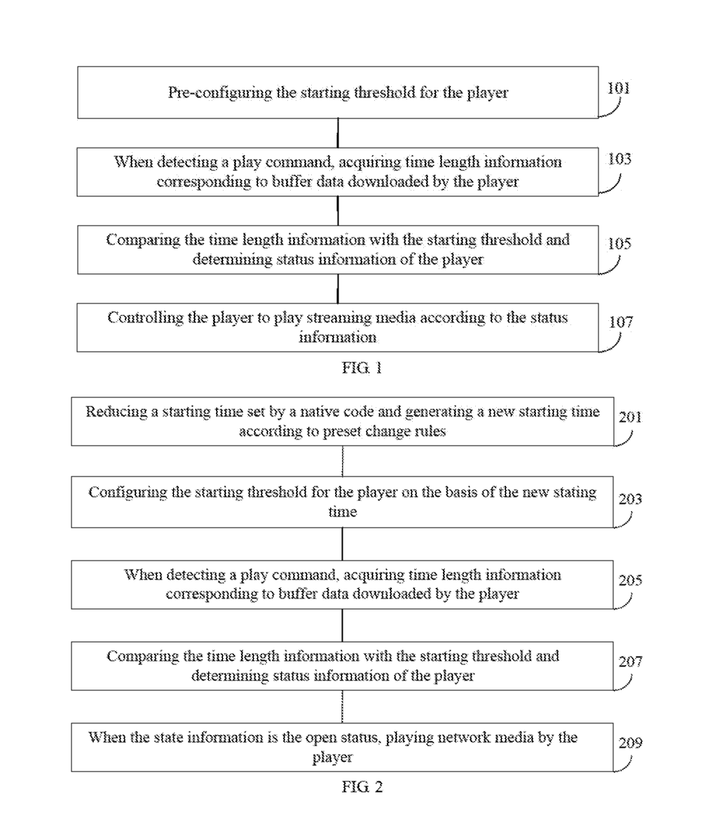

Refer to FIG. 2, which illustrates a step flowchart of a method for playing streaming media according to an embodiment of the present disclosure. The method may specifically include the steps as follows.

Step 201: reducing the starting time set by the native code and generating a new starting time according to the preset change rules.

Specifically speaking, an appropriate preparation threshold and an appropriate starting threshold of the player can be determined on the basis of the network status information such as the Internet speed, network jitter, network bandwidth, etc., thereby determining the change rules of the starting time of the player and saving the change rules in the terminal system. In the change rules of the starting time, an appropriate preparation threshold of the player can be marked as a preparatory starting time; an appropriate adjustment threshold of the player can be marked as an adjustable starting time; and the native threshold of Google is marked as the starting time set by the native code. The change rules of the starting time of the player that are stored by the system are equivalent to preset change rules. According to the change rules. the starting time set by the native code can be reduced, and a new starting time be generated. For example, according to the preset change rules of the system, the starting time set by the native code is gradually reduced by a unit of value in turn; when the starting time set by the native code is reduced to the adjustable starting time, a first new starting time is generated; after the first new starting time is generated, the starting time set by the native code is continuously gradually reduced by a unit of value in turn until the starting time set by the native code is reduced to the preparatory starting time, and then a second new time is generated.

Step 203: configuring the starting threshold for the player on the basis of the new stating time.

Actually, the first new starting time can be used as the adjustment threshold, and the second new starting time is used as the preparation threshold.

As a specific example of the embodiment of the present disclosure, according to the change rules, the starting time set by the native code can be reduced, and then the first new starting time and the second new starting time are generated, for example, the adjustment threshold of the player is configured as 1 s, and the preparation threshold of the player is configured as 300 ms.

Step 205, when detecting the play command, acquiring the time length information corresponding to the buffer data downloaded by the player,

Step 207: Comparing the time length information with the starting threshold and determining the status information of the player.

Actually, when the play command is detected, the play command can be identified to determine which type of play command that the play command belongs to, for example initial play command, and then the starting threshold corresponding to the play command is acquired via interfaces. Determining if the time length corresponding to the current buffer data downloaded by the player is greater than the acquired starting threshold. When the time length corresponding to the current buffer data downloaded by the player is greater than the acquired starting threshold, the state information of the player can be set as the open status.

In an optimal embodiment of the present disclosure, the step of comparing the time length information with the starting threshold and determining the status information of the player can include the following sub-steps.

Sub-step 20701: when the play command is the initial play command, calling the first interface to acquire the preparation threshold.

Sub-step 20703: determining whether the time length information is greater than the preparation threshold.

Sub-step 20705: when the time length information is greater than the preparation threshold, setting the state information of the player as the open state.

When it is detected that the play command belongs to an initial play command, the preparation threshold of the player can be acquired by calling the first interface, for example an interface in a play list Playlist, and whether the time length corresponding to the current buffer data downloaded by the player is greater than the preparation threshold is determined. When the time length corresponding to the current buffer data is greater than the preparation threshold, the state information of the player can be set as the open status, so the player can play the video.

In another optimal embodiment of the present disclosure, the step of comparing the time length information with the starting threshold and determining the status information of the player can also include the sub-steps as follows.

Sub-step 20711: when the play command is the adjustable play command, calling the second interface to acquire the adjustment threshold.

Sub-step 20713: determining whether the time length information is greater than the adjustment threshold.

Sub-step 20714: when the time length information is greater than the adjustment threshold, setting the state information of the player as the open state.

When it is detected that the play command belongs to an adjustable play command, the adjustment threshold of the player can be acquired by calling the second interface, for example an interface in a downloading task. LiveSession, and whether the time length corresponding to the current buffer data downloaded by the player is greater than the adjustment threshold is determined. When the time length corresponding to the current buffer data is greater than the adjustment threshold, the state information of the player can be set as the open status, so the player can play streaming media.

Step 209: when the state information is the open status, playing streaming media by the player.

Specifically speaking, when detecting that the status information of the player is the open status, for example, when detecting the prepare done message, the player can play streaming media.

In the embodiment of the present disclosure, the player is pre-configured with the preparation threshold; when detecting the initial play command, for example when the player plays the selected video for the first time, the status information of the player is confirmed through determining if the time length corresponding to the current buffer data is greater than the preparation threshold of the player, and when the state status information is the open status, the player starts to play the video. Through configuring a smaller preparation threshold in the player, with the starting efficiency of the player improved, while the user can watch the video screens in the shortest time, further improving the user experience.

In the embodiment of the present disclosure, the player is also configured with the adjustment threshold; when detecting the adjustment play command, namely the fast-forward and fast-backward operations, the status information of the player is confirmed through determining if the time length corresponding to the current buffer data is greater than the adjustment threshold of the player, and when the player's status information is the open status, the player starts to play streaming media. Through an appropriate adjustment threshold, the starting efficiency of the player is improved, while the phenomenon of getting stuck caused by frequent buffering of the player is avoided, improving the user experience.

It is needed to be noted that, for simple description, the method embodiments are described as a series of action combinations, but a person skilled in the art understands that the embodiments of the present disclosure are not limited by the sequence of the described actions because according to the embodiments of the present disclosure, some steps can be implemented in other sequence or at the same time. Moreover, a person skilled in the art also should understand that the embodiments described in the present disclosure all belong to optimal embodiments. and some actions involved are not always needed by the embodiments of the present disclosure.

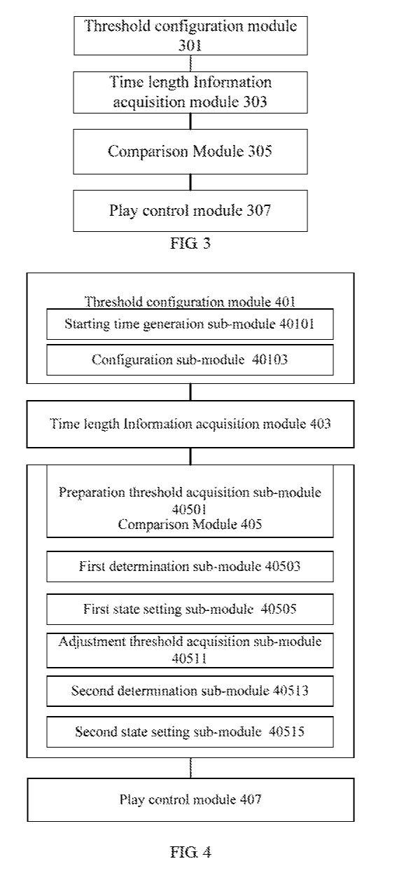

Refer to FIG. 3, which illustrates a structural block diagram of a device for playing streaming media according to an embodiment of the present disclosure. The device can specifically include:
a threshold configuration module 301, capable of being used for pre-configuring the starting threshold for the player;
a time length information acquisition module 303, capable of being used for, when detecting the play command, acquiring the time length information corresponding to the buffer data downloaded by the player;
a comparison module 305, capable of being used for comparing the time length information with the starting threshold and determining the status information of the player; and
a play control module 307 capable of being used for controlling the player to play streaming media according to the status information.

Wherein, streaming media is also called streaming-oriented media, referring to continuous time-based media employing the streaming transfer technology in the Internet or Intranet, such as audio, video, multimedia files, etc. Optionally, streaming media at least include any one of the following types: audio, video and other multimedia files such as cartoons.

In the embodiment of the present disclosure, the player can be pre-configured with the starting threshold on the basis of the network status information, avoid using the native threshold of Google to set the starting conditions of the player, and shortening the starting time of the player. Therefore, the player can play the streaming media when the play time length of the buffer data is relatively small, thus improving the starting efficiency of the player while shortening the users' time of waiting for play, and improving user experience at the same time.

Refer to FIG. 4, which illustrates a structural block diagram of a device for playing streaming media according to an optimal embodiment. The device can specifically include the following modules:
a threshold configuration module 401, capable of being used for pre-configuring the starting threshold for the player.

Optionally, the threshold configuration module 401 can include the following sub-modules:
a starting time generation sub-module 40101, used for reducing the starting time set by the native code and generating a new starting time according to the preset change rules.
a configuration sub-module 40103, used for configuring the starting threshold for the player on the basis of the new stating time; and
a time length information acquisition module 403, capable of being used for, when detecting the play command, acquiring the time length information corresponding to the buffer data downloaded by the player;

In an optimal embodiment of the present disclosure, the play command can include an initial play command and an adjustment play command. The starting threshold can include a preparation threshold and an adjustment threshold; and the preparation threshold is smaller than an adjustment threshold.

Wherein, the preparation threshold aims at the starting threshold configured for the player when the player plays the video for the first time, which means that the play command is the initial play command and the adjustment threshold aims at the starting threshold configured for the player when the play progress is adjusted, which means that the play command is the initial play command.

In addition, a comparison module 405 is included, which is capable of being used for comparing the time length information with the starting threshold and determining the status information of the player.

In an optimal embodiment of the present disclosure, the comparison module 405 can include the following sub-modules:
a preparation threshold acquisition sub-module 40501, capable of being used for calling the first interface to acquire the preparation threshold when the play command is the initial play command;
a first determination sub-module 40503, capable of being used for determining whether the time length information is greater than the preparation threshold; and
a first status setting sub-module 40505, capable of being used for setting the state information of the player as the open state when the time length information is greater than the preparation threshold.

Optionally, the comparison module 405 can also include the following sub-modules:
an adjustment threshold acquisition sub-module 40511, capable of being used for calling the second interface to acquire the adjustment threshold when the play command is the adjustable play command;
a second determination sub-module 40513, capable of being used for determining whether the time length information is greater than the adjustment threshold;
a second status setting sub-module 40515, capable of being used for setting the state information of the player as the open state when the time length information is greater than the adjustment threshold; and
a play control module 407, capable of being specifically used for controlling the player to play streaming media when the status information is the open status.

In the embodiment of the present disclosure, the player is pre-configured with the preparation threshold; when detecting the initial play command, for example when the player plays the selected video for the first time, the status information of the player is confirmed through determining if the time length corresponding to the current buffer data is greater than the preparation threshold of the player, and when the state status information is the open status, the player starts to play the video. Through configuring a smaller preparation threshold in the player, with the starting efficiency of the player improved, while the user can watch the video screens in the shortest time, further improving the user experience.

In the embodiment of the present disclosure, the player is also configured with the adjustment threshold; when detecting the adjustment play command, namely the fast-forward and fast-backward operations, the status information of the player is confirmed through determining if the time length corresponding to the current buffer data is greater than the adjustment threshold of the player, and when the player's status information is the open status, the player starts to play streaming media. Through an appropriate adjustment threshold, the starting efficiency of the player is improved, while the phenomenon of getting stuck caused by frequent buffering of the player is avoided, improving the user experience.

The device embodiment is basically the same as the method embodiments and therefore is simply described. Related contents can be seen in the related description of the method embodiments.

All embodiments of the present disclosures are described in a progressive manner. Every embodiment focuses on different factors. Identical and similar parts of the embodiments can be reference of one another.

A person skilled in the art should understand that the embodiments of the present disclosure can be provided methods, devices or computer program products. Therefore, the embodiments of the present disclosure can be complete hardware embodiments, complete software embodiments or embodiments in combination of software and hardware. Besides, the embodiments of the present disclosure can be one or more computer program products implemented in computer accessible storage media (including but not limited to magnetic disc memories, CD-ROM, optical memories, etc.) which contain accessible program codes for computers.

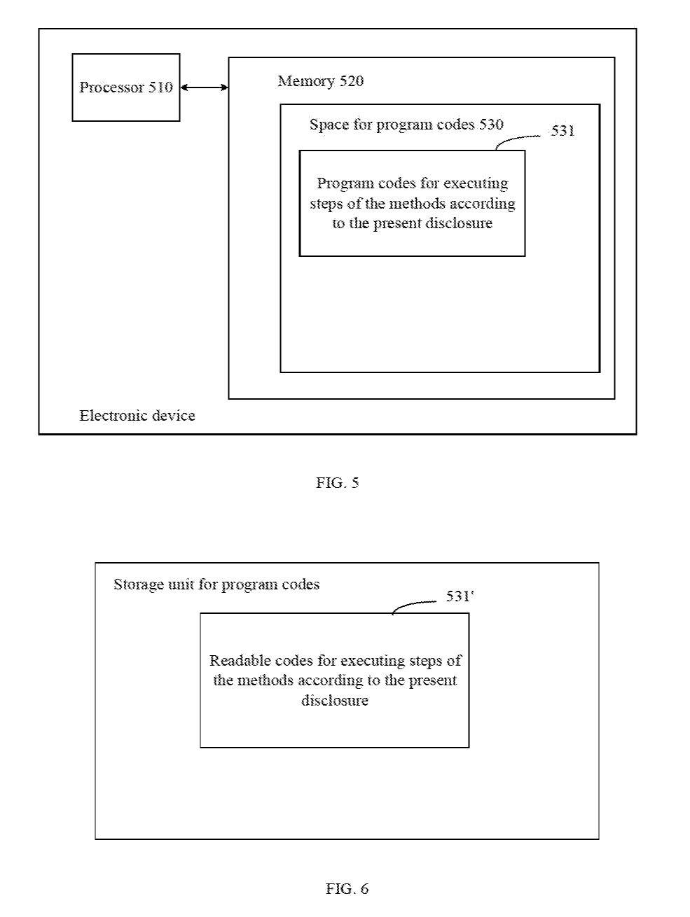

For example, FIG. 5 illustrates a block diagram of an electronic device for executing the method according the disclosure. Traditionally, the electronic device includes a processor 510 and a computer program product or a computer readable medium in form of a memory 520. The memory 520 could be electronic memories such as flash memory, EEPROM (Electrically Erasable Programmable Read-Only Memory), EPROM, hard disk or ROM. The memory 520 has a memory space 530 for executing program codes 531 of any steps in the above methods. For example, the memory space 530 for program codes may include respective program codes 531 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 6. The memory cells may be provided with memory sections, memory spaces, etc., similar to the memory 520 of the electronic device as shown in FIG. 5. The program codes may be compressed for example in an appropriate form. Usually, the memory cell includes computer readable codes 531′ which can be read for example by processors 510. When these codes are operated on the electronic device, the electronic device may execute respective steps in the method as described above.

The embodiments of the present disclosure are described with reference to the flowcharts and/or block diagrams of the methods and terminal devices (system) and computer program products of the embodiments of the present disclosure. It should be understood that the computer program commands realize every process and/or block in the flowcharts and/or block diagrams, and the combination of processes and/or blocks in the flowcharts and/or block diagrams. The computer program command can be supplied to the processor of a universal computer, a special computer, an embedded processing machine or other programmable data processing terminals to generate a machine, so the commands executed. by the processor of the computer or other programmable data processing terminals generate a device for realizing specific functions in one or more processes in the flowcharts and/or one or more blocks in the block diagrams.

The computer program commands can also be stored in computer readable memories which guide the computer or other data processing terminal devices to work in a specific mode so the commands stored in the computer readable memories generate products including command devices, and the command devices conduct specific functions in one or more steps in the flowcharts and/or one or more blocks in the block diagrams.

The computer program commands can also be loaded in the computer or other programmable data processing terminal devices such that computer or other programmable processing terminal devices execute a series of operations to generate processing executed by the computer. Thus, the commands executed in the computer or other programmable terminal devices supply processes of conducting specific functions in one or more processes in the flowcharts and/or one or more blocks in the block diagrams.

Although the optimal embodiments of the present disclosure are described, a person skilled in the art can make other changes and modifications on those embodiments when understanding the basic creative concept. Therefore, the protection scope of the claims includes the optimal embodiments and all changes and modifications within the embodiments of the present disclosure.

Finally, it is needed to be noted that, in the text, the relationship terms such as the “first” and the “second” are used for merely distinguishing an entity or operation from another entity or operation, and it is not always required or hinted that those entities or operation have such practical relationships or are in such sequences. Besides, the terms “comprise”, “include” or any other synonyms are intended to cover non-exclusive inclusion, so the processes, methods, articles or terminal devices of a series of elements include not only those elements, but also other elements, which are not clearly listed, or also include all inherent factors of those processes, methods, articles or terminals device. In the case of no more limit, the elements defined by the sentence “comprising/including a/an . . . ” should. not exclude that the processes, methods, articles or terminal devices including the elements also include other identical elements.

The above are detailed description of the method for playing streaming media and a device for playing streaming media. Specific examples are used in the text to describe the principle and implementation mode of the present disclosure. The description of the above embodiments is only used for the purpose of clarifying the method and essential concepts of the present disclosure. Meanwhile, for a person skilled in the art, changes may be made to the specific implementation modes and application scope according to the concept of the present disclosure. In conclusion, the contents of the description cannot be regarded as limit in the present disclosure.

What is claimed is:

1. A method for playing streaming media, comprising:
at an electronic device:
pre-configuring a starting threshold for a player;
when detecting a play command, acquiring time length information corresponding to buffer data downloaded by the player;
comparing the time length information with the starting threshold and determining status information of the player;
and controlling the player to play streaming media according to the status information.

2. The method according to claim 1, wherein, the step of pre-configuring the starting threshold for the player comprises:
reducing a starting time set by a native code and generating a new starting time according to preset change rules;
and configuring the starting threshold for the player on the basis of the new stating time.

3. The method according to claim 1, wherein, the play command comprises an initial play command and an adjustment play command; the starting threshold comprises a preparation threshold and an adjustment threshold; and the preparation threshold is smaller than the adjustment threshold.

4. The method according to claim 3, wherein, the step of comparing the time length information with the starting threshold and determining the status information of the player comprises:
when the play command is the initial play command, calling a first interface to acquire the preparation threshold;
determining whether the time length information is greater than the preparation threshold;
and when the time length information is greater than the preparation threshold, setting the state information of the player as open status.

5. The method according to claim 4, wherein, the step of comparing the time length information with the starting threshold and determining the status information of the player also comprises:
when the play command is the adjustable play command, calling a second interface to acquire the adjustment threshold;
determining whether the time length information is greater than the adjustment threshold;
and when the time length information is greater than the adjustment threshold, setting the state information of the player as the open status.

6. The method according to claim 5, wherein, the step of controlling the player to play streaming media according to the status information comprises:
when the state information is the open status, playing streaming media by the player.

7. The method according to claim 4, wherein the streaming media comprises at least one of the following types: audio and video.

8. An electronic device for playing streaming media, comprising:
at least one processor; and
a memory communicably connected with the at least one processor for storing instructions executable by the at least one processor, wherein execution of the instructions by the at least one processor causes the at least one processor to:
pre-configure the starting threshold for the player;
acquire the time length information corresponding to the buffer data downloaded by the player when detecting the play command;
compare the time length information with the starting threshold and determine the status information of the player;
control the player to play streaming media according to the status information.

9. The electronic device according to claim 8, wherein, configure the starting threshold for the player comprises:
reduce the starting time set by the native code and generating a new starting time according to the preset change rules;
configure the starting threshold for the player on the basis of the new stating time.

10. The electronic device according to claim 8, wherein, the play command comprises an initial play command and an adjustment play command; the starting threshold includes a preparation threshold and an adjustment threshold; and the preparation threshold is smaller than an adjustment threshold.

11. The electronic device according to claim 10, wherein, compare the time length information with the starting threshold and determine the status information of the player comprises:
call the first interface to acquire the preparation threshold when the play command is the initial play command;
determine whether the time length information is greater than the preparation threshold;
set the state information of the player as the open state when the time length information is greater than the preparation threshold.

12. The electronic device according to claim 11, wherein, compare the time length information with the starting threshold and determine the status information of the player further comprises:
call the second interface to acquire the adjustment threshold when the play command is the adjustable play command;
determine whether the time length information is greater than the adjustment threshold;
set the state information of the player as the open state when the time length information is greater than the adjustment threshold.

13. The electronic device according to claim 12, wherein, control the player to play streaming media according to the status information comprises control the player to play streaming media when the status information is the open status.

14. The electronic device according to claim 11, wherein the streaming media comprises at least one of the following types: audio and video.

15. A non-transitory computer readable medium storing executable instructions that, when executed by an electronic device, cause the electronic device to:
pre-configure the starting threshold for the player;
acquire the time length information corresponding to the buffer data downloaded by the player when detecting the play command;
compare the time length information with the starting threshold and determine the status information of the player;
control the player to play streaming media according to the status information.
